(19) United States
(12) Patent Application Publication
(10) Pub. No.: US 2018/0182218 A1
(43) Pub. Date: Jun. 28, 2018

(54) FIRE DETECTION SYSTEM

(71) Applicant: Marc TOLAND, Stamford, CT (US)

(72) Inventor: Marc TOLAND, Stamford, CT (US)

(21) Appl. No.: 15/905,377

(22) Filed: Feb. 26, 2018

Related U.S. Application Data
(63) Continuation-in-part of application No. 15/239,377, filed on Aug. 17, 2016, now abandoned.

(51) Int. Cl. G08B 17/117; G08B 25/10; H04W 4/70; H04M 1/725

(52) U.S. Cl. CPC G08B 17/117; G08B 25/10; A62C 3/16; H04M 1/72527; H04W 4/70

(57) ABSTRACT

A fire alert system includes an integrated environment detector such as a fire detector with one or more sensors. The integrated environment detector can be incorporated into an electrical outlet with one or more electrical sockets. In an alternative form, the fire detector is completely standalone, wireless and mobile, not hardwired to the electricity of a building, but powered by battery. In either form, the fire detector has one or more sensors: carbon monoxide, heat, particle, gas and smoke. A wireless transmitter is operatively associated with the sensors for identifying an environmental event such as a fire event.

### CROSS REFERENCE TO RELATED APPLICATION

This application is a Continuation-in-Part of U.S. application Ser. No. 15/239,377 filed on Aug. 17, 2016, herein incorporated by reference.

### FIELD OF THE INVENTION

The present invention relates to an environment detector and in one specific form, a mobile wireless environment detector with integral fire detector.

### BACKGROUND OF THE INVENTION

Emergency detection systems such as fire detection systems alert occupants and emergency professionals of possible fire emergencies. Fire detection systems have been developed to place fire detectors in differing environments and for sensing different events that signify the presence of a fire. Some prior systems include smoke detectors, particle detectors and heat sensors, individually or possibly in combination, to detect a possible fire.

Traditional fire detectors are stand-alone devices that are either powered by battery or may be hardwired to a facility's electrical system. Most modern municipal building codes, standards and regulations require fire detectors to be hardwired to a building's electrical power with battery backup in the event of a power failure. Accordingly, for fire detector installation, one must physically connect the fire detector to the electrical power in the building. This limits the location in which fire detectors can be located within a building and limits the ease of fire detection deployment.

### SUMMARY OF THE INVENTION

The present invention is directed to a fire detector that can be either hardwired to the electrical wiring in a building or, in one advantageous form, completely standalone cordless, mobile and wireless. The fire detector has an integrated or built-in environment detector such as a fire detector. In its hardwired form, the fire detector can be integrated into an electrical outlet socket for easy installation in an existing building as well as new construction. In its standalone, completely mobile, wireless form, the present fire detector can be easily located anywhere in a residential or commercial building, that there is a threat of a fire. The completely mobile wireless form is especially beneficial for use with an existing building but also can be deployed in new construction as well. The standalone fire detector can be adhered to a surface using a command strip that allows one to easily remove the fire detector and place it in a new location at any time.

The fire detector has one or more sensors such as a carbon monoxide, heat, particle, gas and smoke sensor. In one advantageous form, the mobile fire detector includes a carbon monoxide sensor and at least one other sensor such as a heat, particle, gas and smoke sensor.

A wireless transmitter is operatively associated with the one or more sensors. In use, the fire detector sends a signal wirelessly to a remote alarm, monitoring station, or mobile electronic device such as a smart phone to alert one that a possible fire has been detected.

Advantageously, the one or more sensors allows for a more accurate identification of a fire event. For example, a computer processor, disposed within the fire detector, identifies a fire event based on input from the sensors. Alternatively, a computer processor can be located remote from the sensors (i.e., away from the fire detector) and operatively associated with the sensors preferably via a wireless signal to a computer network (e.g., a local area network (LAN), wide area network (WAN) or the internet). As with a processor which can be located within fire detector housing, the remote processor includes logic for identifying a fire event based on information generated from the sensors.

The present invention, in one form thereof, is directed to an electrical wall outlet with integrated fire detector. The wall outlet has an electrical outlet receptacle with one or more electrical sockets. The electrical outlet receptacle is adapted to be disposed in an electrical outlet box. A carbon monoxide sensor is disposed within or integral with the electrical receptacle. At least one additional sensor selected from the group consisting of heat, particle, gas and smoke is also disposed within or integral with the electrical receptacle. A wireless transmitter is operatively associated with the carbon monoxide sensor and the at least one additional sensor. In specific, further advantageous form, the electrical outlet has a computer network connection associated with the carbon monoxide sensor.

The present invention, in another form thereof is directed to a system for detecting fire. The system has an electrical outlet receptacle with one or more electrical sockets. The electrical outlet is adapted to be disposed in an electrical outlet box. A carbon monoxide sensor and at least an additional sensor selected from the group consisting of heat, particle, gas and smoke is disposed within or is integral with the electrical receptacle. A wireless transmitter is operatively associated with the carbon monoxide sensor and at least one additional sensor. An alert device has a receiver to wirelessly connect the alert device to the carbon monoxide sensor and the at least one additional sensor via the wireless transmitter.

The present invention in another form thereof is directed to an electrical wall outlet with integrated environment detector. The wall outlet has a housing adapted to be disposed in an electrical outlet box. One or more electric sockets are disposed within the housing. A at least one sensor selected from the group consisting of carbon monoxide, heat, particle, gas and smoke are disposed within or integral with the housing. A wireless transmitter is operatively associated with the sensor(s). In one further advantageous form, a computer processor is operatively associated with the sensor(s), to identify the presence of an environmental event such as a fire, gas leak, etc.

The present invention in another form thereof is directed to a cordless, wireless fire detector system. The system has at least one sensor selected from the group consisting of carbon monoxide, heat, particle, gas and smoke. A wireless transmitter is operatively associated with the at least one sensor. A battery provides power to the at least one sensor and the wireless transmitter. The at least one sensor and the wireless transmitter are exclusively powered by not being hardwired or physically connected to electrical power of a building.

The present invention in another form thereof is directed to a system for detecting fire. The system includes at least one sensor selected from the group consisting of carbon monoxide, heat, particle, gas and smoke. A wireless transmitter is operatively associated with the at least one sensor. A battery provides power to the at least one sensor and the wireless transmitter. The at least one sensor and the wireless transmitter exclusively are powered by not being hardwired or physically connected to electrical power of a building. An alert device has a receiver to wirelessly connect the alert device to the at least one sensor via the wireless transmitter.

### BRIEF DESCRIPTION OF THE DRAWINGS

FIG. 1 is a schematic showing a system for detecting an environmental event such as a fire in accordance with the present invention.

FIG. 2 is an electrical outlet with integrated fire detector in accordance with the present invention.

FIG. 3 is an electrical outlet box into which the electrical outlet with integrated fire detector of FIG. 2 can be disposed.

FIG. 4 is a front elevation view of the electrical outlet of FIG. 2 disposed within the electrical outlet box of FIG. 3.

FIG. 5 is a cross section view of the electrical outlet box of FIG. 4 taken along line 5-5.

FIG. 6 is a schematic showing a second embodiment of a system for detecting an environmental event such as a fire in accordance with the present invention.

FIG. 7 is a schematic showing aspects of the electrical outlet with integrated fire detector in accordance with the present invention.

### DETAILED DESCRIPTION

The present invention will now be described with reference to the Figures.

### Hardwired Fire Detection System

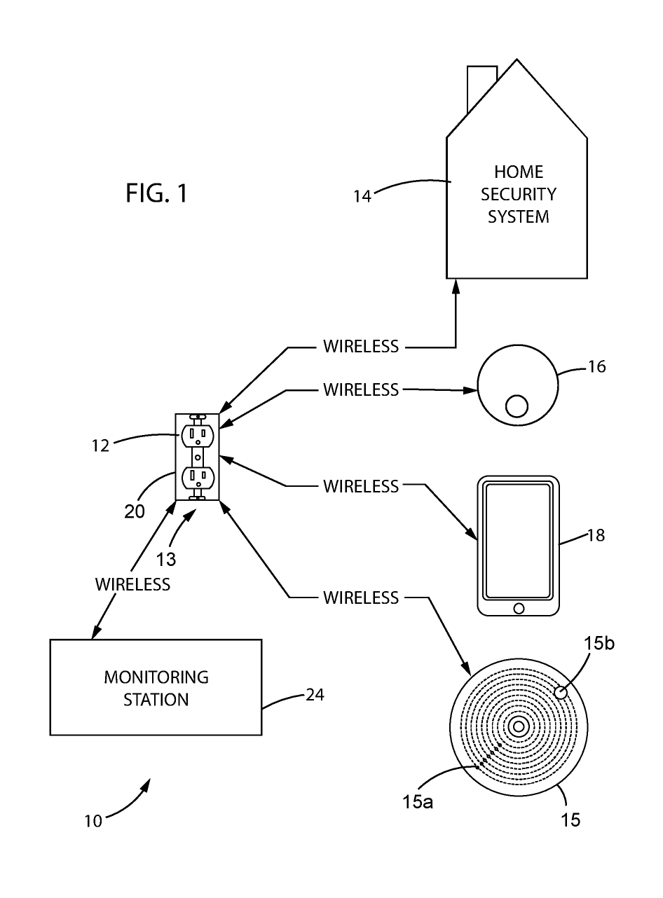

FIG. 1 is a schematic showing a first embodiment of a fire detection system, fire alert system 10, which includes a housing or receptacle 20 such as electrical outlet 12 with an integrated fire detector 13. The fire detector 13 wirelessly connects to various receivers or devices including a home security system 14, a remote alarm 15, smoke detector 16, an electronic mobile device 18, and a monitoring station 24. The receivers, e.g. a remote alarm 15, smoke detector 16 and a monitoring station 24 can have their own, respective environment sensors such as a carbon monoxide sensor, heat, particle, gas and smoke. Although only one electrical outlet 12 is shown in FIG. 1 for simplifying the schematic, the system 10 can have a number of outlets 12 located throughout a building to act as a network of fire detectors.

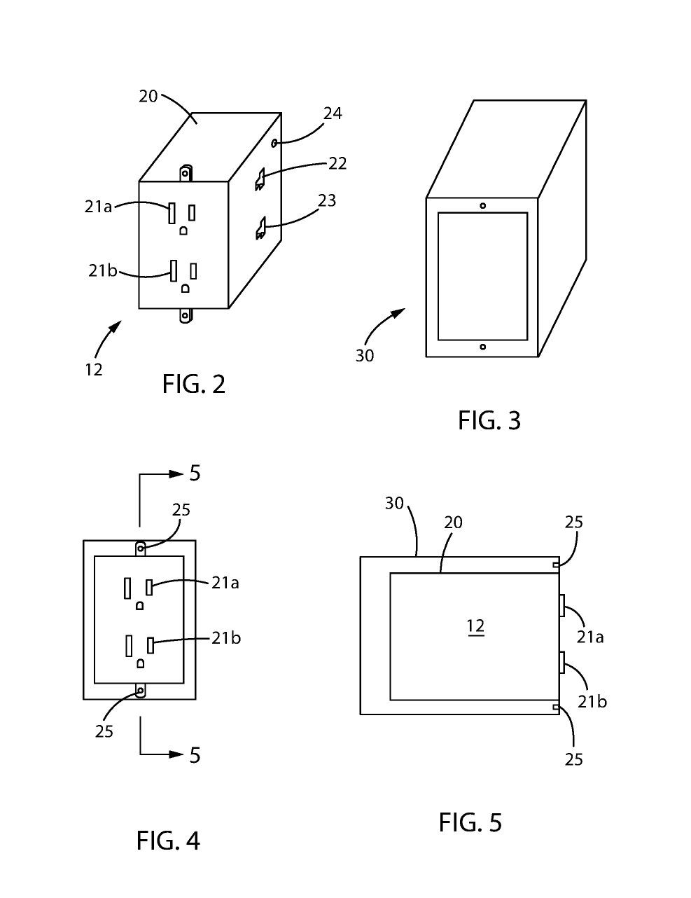

Referring now to FIGS. 2-5 along with FIG. 1, the electrical outlet 12 has a housing or receptacle body 20 which holds or houses two electrical sockets 21a, 21b. Alternatively, if desired, the electrical outlet can include additional sockets, a light switch or other conventional electrical outlet receptacle devices including but not limited to switches, ground fault interrupters (GFI), etc.

Terminals 22, 23 are used to connect the electrical outlet receptacle 20 to current in a building such as a 120/220 supply with a ground wire connected to terminal 24.

Advantageously, the electrical outlet receptacle 20 can be disposed within a conventional electrical box 30 (FIG. 3). FIGS. 4 and 5 show a typical installation of the electrical outlet receptacle 20 installed in the electrical outlet box 30 and held in place by screws 25.

### Mobile Fire Detection System

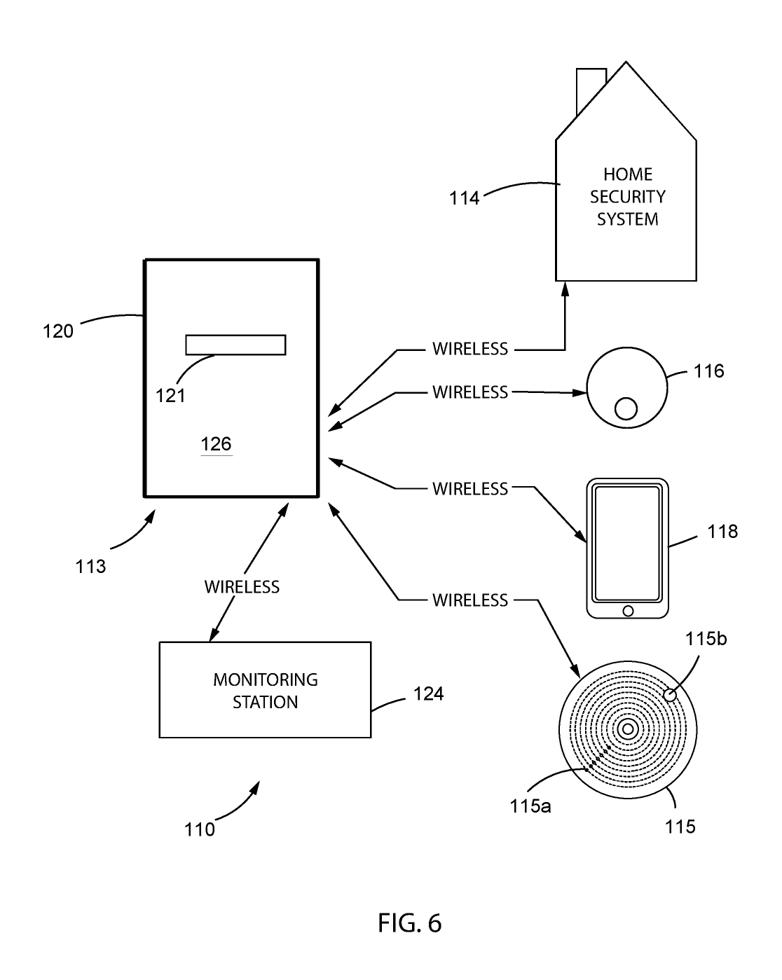

In a second embodiment, as show schematic in FIG. 6, fire alert system 110 is a standalone, completely mobile, wireless fire detection system. Like elements to those of fire alert system 10 are increased by 100 in FIG. 6. Accordingly, full descriptions of like features and functions will not be repeated, concentrating on the differences of those elements relevant to fire alert system 110.

The fire alert system 110 has one more standalone, completely mobile, fire detectors 113 within a housing 120, each having one or more sensors. Housing 120 is mounted or adhered to a location of choice, e.g. a surface, such as a wall or shelf, using command strip 121 (one it back and/or on its bottom). The command strip 121 allows on to remove the standalone fire detector 113 and place it in new locations at any time. The command strip can be an adhesive material.

As with fire alert system 10 of FIG. 1, FIG. 6 is simplified to only show a single fire detector 13. Also, as with the fire alert system 10, the fire alert detector 113 wirelessly connects to various receivers or devices including a home security system 114, smoke detector 116, an electronic mobile device 118, a remote alarm 115 and a monitoring station 124. The receivers, e.g. smoke detector 116, a remote alarm 115 and a monitoring station 124 can have their own, respective environment sensors such as a carbon monoxide sensor, heat, particle, gas and smoke. Although only fire detector 113 is shown in FIG. 6 for simplifying the schematic, the system 110 can have a number of fire detectors 113 located throughout a building to act as a network of fire detectors.

Unlike fire detector 13, fire detector 113 is not hardwired to the current in a building. Instead, fire detector 113 is powered by battery 126. In one advantageous form, the exclusive power source is battery 126. As a result, fire detector 113 can be placed anywhere there is a threat of a fire and where one wishes to detect a fire and is not constrained to a physical connection to a building's current or electrical supply. Accordingly, the standalone fire detector 113 which operates exclusively by battery and does not require an electrical source vastly improves fire detection and/or protection over prior fire detectors and their respective systems that limit fire detector deployment to locations with electrical power. This is especially advantageous for placement in locations that do not have electricity such as a shed, barn, cabin/tent/camper/RV, etc.

### Fire Detection

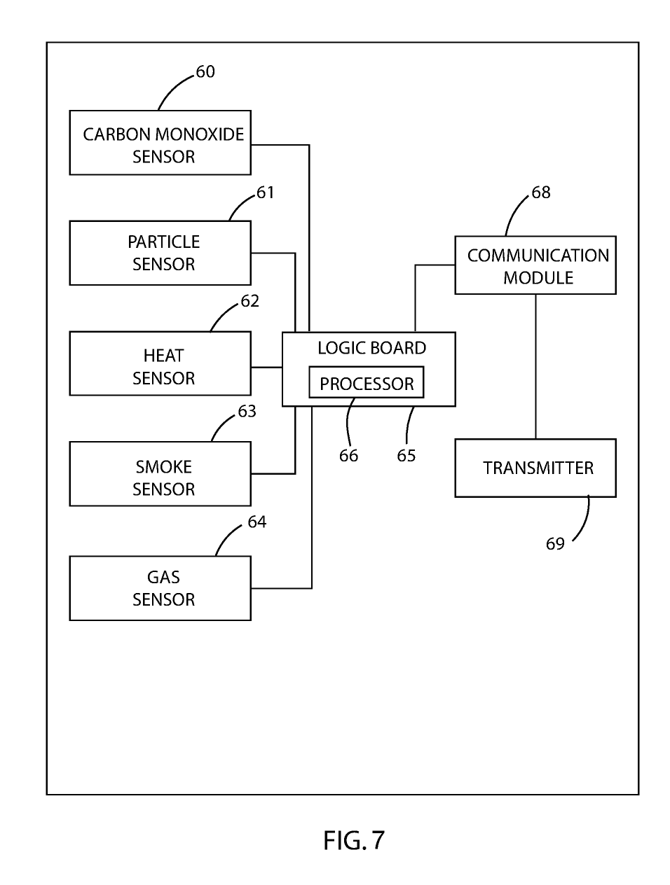

Fire detection using fire alert system 10,110 will now be described with reference to FIG. 7 along with FIGS. 1 and 6. Housing 20,120 is shown as a schematic to simplify understanding of its integrated fire detector 13,113. Elements shown in FIG. 7 schematically are either disposed within or along an exterior surface of the housing the housing 20,120, as appropriate and desired in accordance with this disclosure. The fire detector 13,113 has several sensors including a carbon monoxide sensor 60, a particle sensor 61, a heat sensor 62, a smoke sensor 63, and gas sensor 64. The gas sensor 64 can be adapted to detect various environment gases, including but not limited to carbon dioxide, natural gas and other organic hydrocarbons, scents and odors. Advantageously, each of the sensors 60-64 are connected to a computer board 65 with computer processor 66. Processor 66 includes computer logic for identifying a possible fire event from signals received from the sensors 60-63. When processor 66 identifies a possible fire, the processor 66 sends a signal via communication module 68, via a wired connector or a wireless connection via wireless transmitter 69, indicating the identification of a possible fire or other environmental event.

Referring now to the communication module 68 in more detail, the communication module 68 transmits a wireless signal via transmitter 69 to a receiver which provides audible/visual/communication information to appropriate personal. A non-exclusive list of receivers include, but are not limited to the home security system 14, 114, smoke detector 16,116, electronic mobile device 18, 118, remote alarm 15,115 and monitoring station 24,124 (see, FIGS. 1 and 6). The wireless communication may include any type of wireless transmission technology, including, but not limited to, WiFi, 3G, 2G, 2.5G, 4G, WiMax, BlueTooth. Some, but not all, possible communication networks that may comprise a computer network or be otherwise part of a system that includes a local area network (LAN), a wide area network (WAN), the Internet, a telephone line, a cable line, as well as an RF channel, an optical communications line, and a satellite communications link.

Alternatively or in addition to using the wireless transmitter 69, the communication module 68 can be directly wired to a computer network. For example, the communication module 68 can be hardwired connected to a local area network (LAN), wide area network (WAN) or the Internet.

Identification of a possible fire event can be received wirelessly by various receivers or devices including the home security system 14,114, smoke detector 16,116 electronic mobile device 18,118, remote alarm 15,115 and monitoring station 24,124. For example, the home security system 14,114 smoke detector 16,116 electronic mobile device 18,118 remote alarm 15,115 and monitoring station 24,124 have wireless receivers for receiving signals from the transmitter 69 for wireless communication between the fire detector 13,113 and the aforementioned receivers. The receivers can receive signals either directly from the transmitter 69 or wirelessly via a computer network operatively associated with the communication module 68 and/or transmitter 69. Alternatively, rather than receiving wireless signals, the receivers can be hardwired to a telecommunication or computer network operatively associated with the sensors of the fire detector 13,113. Upon identification of a fire event, an appropriately adapted receiver can alert the fire department or other emergency personal of a possible dangerous event.

In alternative embodiments, the home security system 14,114 smoke detector 16,116 electronic mobile device 18,118 remote alarm 15,115 and monitoring station 24,124 have respective computer processors for receiving and processing information from the sensors in the fire detector 13,113. For example, the monitoring station 24,124 can have its own processor for processing data from the carbon monoxide sensor 60 and other sensors such as heat sensor 62 and smoke sensor 63 to identify a possible fire from the presence of detected carbon monoxide heat and smoke.

In use, when an environmental event such as a fire event is identified for example via processor 66 or respective processors in the receivers which receive data from the sensors in the electrical wall outlet via a wired connection or via transmitter 69, an alert is sent from the receiver to warn occupants and emergency personnel of the fire event. For example, remote alarm 15,115 has a speaker 15a,115a and a light 15b,115b to alert one of a fire event by producing an audible sound or light, respectively.

In another example, the monitoring station 24,124 can be remote from a building to which fire detector(s) 13,113 is/are installed. The monitoring station 24,124 can include human personnel who receive and review data from the sensors (60-64) and alert the appropriate emergency personnel upon receipt of information from the sensors (60-64) in the fire detector 13,113. Alternatively, the monitoring station 24,124 can be completely automated and connected to a telephone line or other connection to remote emergency personnel to alert the emergency personnel that a possible fire event has been detected in the building. In addition, a location in the building of a fire event can be identified from data collected by the sensors (60-64) in the fire 12 deployed throughout a building.

It will now be clear to one of ordinary skill in the art that the present electrical outlet with integrated environment detector such as a fire detector has advantages and functions not found in prior fire detection systems. Having the detector integrated within an electrical outlet receptacle itself allows for easy installation in both new construction as well as retrofitting an existing building. In addition, integrating the detector within the electrical outlet allows for a compact product. Further, the use of a carbon monoxide sensor along with other sensors such as smoke, fire, heat, gas, etc., allows the present fire detector to be more sensitive to accurately identifying a fire event based on the presence of carbon monoxide along with smoke, particle, or heat present. In addition, communicating (advantageously wirelessly) between the sensors' location where carbon monoxide along with smoke, particle, gas or heat is detected, allows for deployment of a sensor at a location where a fire is likely to occur, such as in the proximity of a wall to detect a possible electrical fire, and then transmits the detection of the event for receipt by a wireless device at a remote location from the location where the event is detected. As a result, a central system such as a monitoring station or an electronic mobile device can be used to receive detection of a possible fire event remote from the actual location of the fire or other environmental event.

It will also be clear to one of ordinary skill in the art that the mobile embodiment of the fire detection system offers numerous advantages over hardwired fire detection systems. Since the mobile fire detection detectors are not physically connected to a buildings electrical wiring, one can simply mount the mobile fire detector anywhere one believes a fire may occur.

Although the invention has been described with respect to a preferred embodiment, it is to be understood that the invention is capable of numerous modifications and variations, apparent to those skilled in the art, without departing from the spirit and scope of the invention.

What is claimed is:

1. A cordless, wireless fire detector system, comprising:
at least one sensor selected from the group consisting of carbon monoxide, heat, particle, gas and smoke;
a wireless transmitter operatively associated with the at least one sensor; and
a battery,
wherein the battery provides power to the at least one sensor and the wireless transmitter and
wherein the at least one sensor and the wireless transmitter are exclusively powered by not being hardwired or physically connected to electrical power of a building.

2. The cordless, wireless fire detector system of claim 1, further comprising a housing in which the at least one sensor, the wireless transmitter, and the battery are disposed.

3. The cordless, wireless fire detector system of claim 1, wherein the at least one sensor comprises the carbon monoxide sensor and at least one of the heat, particle, gas and smoke sensors.

4. The wireless fire detector system of claim 3, further comprising a computer processor operatively associated with the carbon monoxide sensor and the at least one other sensor, to identify presence of a fire.

5. The wireless fire detector system of claim 1, further comprising a computer network connection associated with the carbon monoxide sensor.

6. The wireless fire detector system of claim 2, further comprising a command strip for removably adhering the housing to a suitable surface.

7. A system for detecting fire, said system comprising:
at least one sensor selected from the group consisting of carbon monoxide, heat, particle, gas and smoke;
a wireless transmitter operatively associated with the at least one sensor;
a battery providing power to the at least one sensor and the wireless transmitter, wherein the at least one sensor and the wireless transmitter exclusively are powered by not being hardwired or physically connected to electrical power of a building; and
an alert device having a receiver to wirelessly connect the alert device to the at least one sensor via the wireless transmitter.

8. The system of claim 7, wherein the alert device has a speaker for producing an audible sound.

9. The system of claim 7, wherein the alert device has a light source for emitting light.

10. The system of claim 7, further comprising a computer network connection associated with the at least on sensor.

11. The system of claim 10, wherein the at least one sensor comprises the carbon monoxide sensor and at least one of the heat, particle, gas and smoke sensors.

12. The system of claim 11, wherein the computer network connection allows connectivity to a local area network.

13. The system of claim 11, wherein the computer network connection is allows connectivity to the Internet.

14. The system of claim 11, wherein the computer network connection permits alerts to be sent from the carbon monoxide sensor to a mobile communication device.

15. The system of claim 11, further comprising a smoke detector having a wireless receiver to connect wirelessly with the wireless transmitter.

16. The system of claim 11, further comprising a monitor station wirelessly connected to the carbon monoxide sensor.

17. The system of claim 7, a monitor station wirelessly connected to the carbon monoxide sensor.

18. The system of claim 7, further comprising a computer processor operatively associated with the at least one sensor, to identify presence of a fire.

19. The system of claim 11, further comprising a computer processor operatively associated with the at least one sensor, to identify presence of a fire.

20. The system of claim 7, further comprising:
a housing in which the at least one sensor, the wireless transmitter, and the battery are disposed; and
a command strip for removably adhering the housing to a suitable surface.
